(19) United States
(12) Patent Application Publication
(10) Pub. No.: US 2025/0388123 A1
(43) Pub. Date: Dec. 25, 2025

(54) ELECTRIFIED VEHICLE AND METHOD OF CONTROLLING THE SAME

(71) Applicants: Hyundai Motor Company, Seoul (KR); Kia Corporation, Seoul (KR)

(72) Inventors: Ho Sun JANG, Hwaseong-si (KR); Jin Wook KANG, Hwaseong-si (KR)

(73) Assignees: Hyundai Motor Company, Seoul (KR); Kia Corporation, Seoul (KR)

(21) Appl. No.: 18/948,208

(22) Filed: Nov. 14, 2024

(30) Foreign Application Priority Data
Jun. 20, 2024 (KR) 10-2024-0080630

(51) Int. Cl. B60L 58/18; B60L 50/60; B60R 16/023

(52) U.S. Cl. CPC B60L 58/18; B60L 50/66; B60R 16/0236; B60L 2210/40; B60L 2240/526; B60L 2240/54; B60L 2260/26

(57) ABSTRACT

In an electrified vehicle and method for controlling the electrified vehicle, the electrified vehicle may include a main battery, a motor, a first inverter, a second inverter, a plurality of first changeover switches forming a first node, a plurality of second changeover switches forming a second node, and an auxiliary switch including one end selectively connectable to the first node or the second node and the other end selectively connectable to an auxiliary battery in a state where the auxiliary battery is mounted.

### CROSS-REFERENCE TO RELATED APPLICATION

The present application claims priority to Korean Patent Application No. 10-2024-0080630, filed Jun. 20, 2024, the entire contents of which is incorporated herein for all purposes by this reference.

### BACKGROUND OF THE PRESENT DISCLOSURE

### Field of the Present Disclosure

The present disclosure relates to an electrified vehicle configured to accommodate an auxiliary battery in addition to a main battery and a method for controlling the same.

### Description of Related Art

In line with the global trend of reducing carbon dioxide emissions in recent years, there has been a significant increase in the demand for electrified vehicles that generate driving power by driving a motor with electrical energy stored in batteries, as opposed to conventional internal combustion engine vehicles that generate driving power through burning fossil fuels.

The time required to charge the battery is relatively long compared to the refueling time for internal combustion engine vehicles, such that the maximum driving distance which may be traveled with a single full battery charge is a crucial factor for electrified vehicles.

The maximum driving distance of an electrified vehicle may vary depending on the voltage and capacity of the battery. Even with the same capacity, the voltage and charge capacity may differ depending on the serial/parallel connection configurations of the modules or cells. For example, the battery voltage corresponds to the voltage of each battery cell multiplied by the number of cells connected in series, and the battery charge capacity corresponds to the charge capacity of each battery cell multiplied by the number of cells connected in parallel.

Accordingly, increasing the battery voltage may be considered to increase the driving distance, but an increase in the battery voltage requires a stronger withstand voltage design for the motor system, so there is a need to propose a solution to increase the driving distance without increasing the battery voltage.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electrified vehicle and a method for controlling the electrified vehicle configured to increase the driving distance of the electrified vehicle efficiently even in the event of an inverter failure through an auxiliary battery mounted in addition to a main battery.

The issues of the present disclosure are not limited to those described above, and other issues not mentioned will be clearly understood by those skilled in the art from the following description.

An electrified vehicle according to an exemplary embodiment of the present disclosure to address the issues described above, the vehicle being configured to accommodate an auxiliary battery, includes a main battery; a motor including a plurality of windings; a first inverter including a plurality of legs connected to the main battery and connected to a first end of each of the windings; a second inverter including a plurality of legs connected to the main battery and connected to a second end of each of the windings; a plurality of first changeover switches, each including a first end interconnected to form a first node and a second end connected to the second end of each of the windings; a plurality of second changeover switches, each including a first end connected to a second end of the plurality of winding and a second end interconnected to form a second node; and an auxiliary battery including a first end selectively connectable to the first node or the second node and a second end selectively connectable to the auxiliary battery in a state where the auxiliary battery is mounted.

A method for controlling the electrified vehicle according to an exemplary embodiment of the present disclosure to address the issues described above, the vehicle being configured to accommodate an auxiliary battery, includes controlling the drive mode of a motor through a turn-on/off of a charging switches connected between the auxiliary battery and a second end of the auxiliary switch either in a first drive mode in which the motor is driven in a state where the auxiliary battery and the motor are electrically disconnected or in a second drive mode in which the motor is driven in a state where the auxiliary battery and the motor are electrically connected, in a state where the auxiliary battery is mounted; and performing fault diagnostics on at least one of the first inverter and the second inverter while controlling the motor in the second drive mode and controlling a connection status of the auxiliary switch based on diagnosis results, in a state where the auxiliary battery is mounted.

According to various embodiments of the present disclosure as described above, an auxiliary battery may be utilized in conjunction with a main battery for the motor drive so that the driving distance of the electrified vehicle increases efficiently.

Furthermore, switching inverters that drive the motor based on the voltage of the main battery and auxiliary battery in consideration of an inverter failure situation allows the vehicle to continue driving even in the event of an inverter failure such as burnout or damage of elements in the inverter.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating the configuration of an electrified vehicle according to an exemplary embodiment of the present disclosure.

FIG. 2, FIG. 3 and FIG. 4 are views exemplarily illustrating an implementation example of a motor system applicable to various exemplary embodiments of the present disclosure.

FIG. 5 is a view for describing the detailed configuration and operation of a controller according to an exemplary embodiment of the present disclosure.

FIG. 6 is a flowchart for describing a method for controlling an electrified vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The specific structural or functional descriptions of the embodiments of the present disclosure in the present specification or application are merely illustrative examples for describing the embodiments according to an exemplary embodiment of the present disclosure, and the embodiments of the present disclosure may be implemented in various forms and should not be construed as being limited to the embodiments described in the present specification or application.

Since exemplary embodiments of the present disclosure may be modified in various ways and may take many forms, specific embodiments are illustrated in the drawings and described in detail in the present specification or application. However, it should be understood that this is not intended to limit embodiments according to the concepts of the present disclosure to any particular form of disclosure and that all modifications, equivalents, or substitutes that fall within the scope of ideas and techniques of the present disclosure are included.

Unless otherwise defined, all terms used herein, including technical or scientific terms, include the same meanings as are generally understood by those skilled in the art to which the present disclosure pertains. Terms, as defined in commonly used dictionaries, shall be construed as having means consistent with their contextual meanings in the related art and shall not be construed as having idealistic or overly formal meanings unless explicitly defined in the present specification.

Hereinafter, various exemplary embodiments included in the present disclosure will be described in detail with reference to the accompanying drawings, but the same reference numerals will be assigned to the similar or same components regardless of drawing numbers and repetitive descriptions will be omitted.

In the following description of the embodiments, the term “preset” means that the value of a parameter is predetermined when the parameter is used in a process or algorithm. The value of the parameter may be set at the start of the process or algorithm or may be set during the execution of the process or algorithm, depending on the embodiment.

The suffixes “module” and “unit” for the components used in the following description are provided or interchangeably used only to facilitate the writing of the specification, without necessarily indicating a distinct meaning or role of their own.

When it is determined that the specific description of the related and widely known technology may obscure the essence of the embodiments included herein, the specific description will be omitted. Furthermore, it is to be understood that the accompanying drawings are only intended to facilitate understanding of the embodiments included herein and are not intended to limit the technical ideas included herein are not limited to the accompanying drawings and include all the modifications, equivalents, or substitutions within the spirit and technical scope of the present disclosure.

The terms including ordinal numbers such as first, second, and the like may be used to describe various components, but the components are not to be limited by the terms. The terms may only be used for distinguishing one component from another.

It is to be understood that when a component is referred to as being “connected” or “coupled” to another component, the component may be directly connected or coupled to another component, but other components may be interposed therebetween. In contrast, it is to be understood that no other component is interposed when a component is referred to as being “directly connected” or “directly coupled” to another component.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

Furthermore, a unit or a control unit included in the names such as a motor control unit (MCU), a hybrid control unit (HCU), and the like is a term widely used in the naming of control units that control specific functions of a vehicle and does not mean a generic function unit.

Each control unit may include a communication device that communicates with other control units or sensors to control the functions for which the control unit is responsible, a memory that stores a drive system or logic instructions and input and output information, and one or more processors that perform determinations, calculations, decisions, and the like required for controlling the functions for which the control unit is responsible.

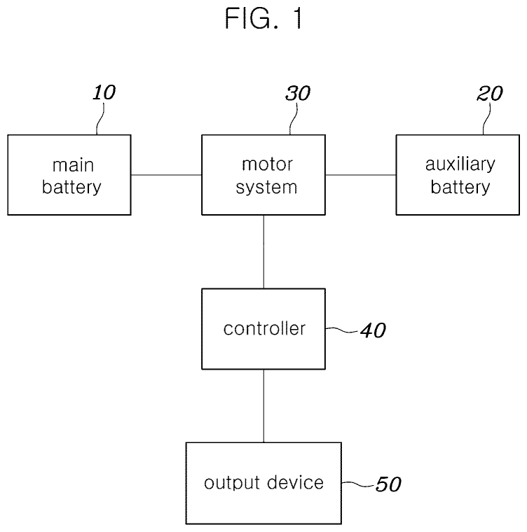

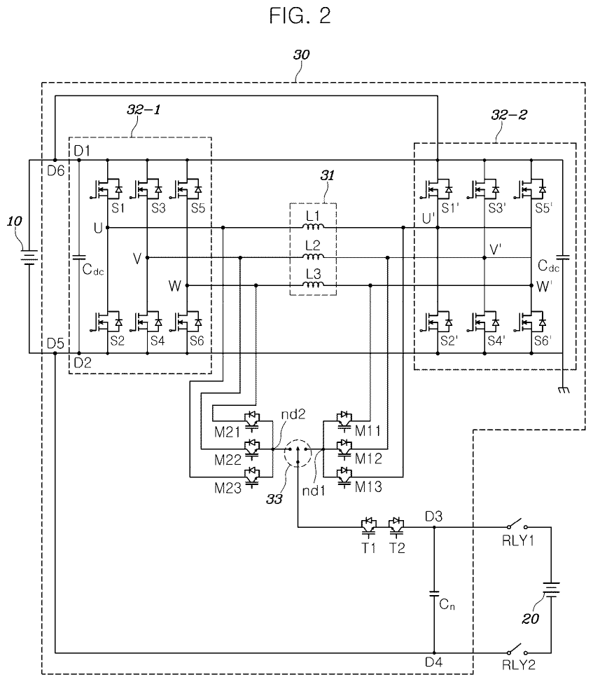

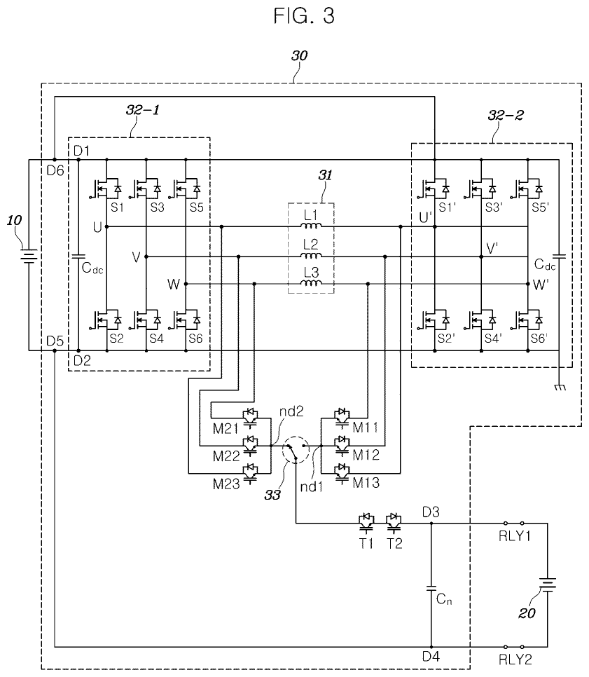

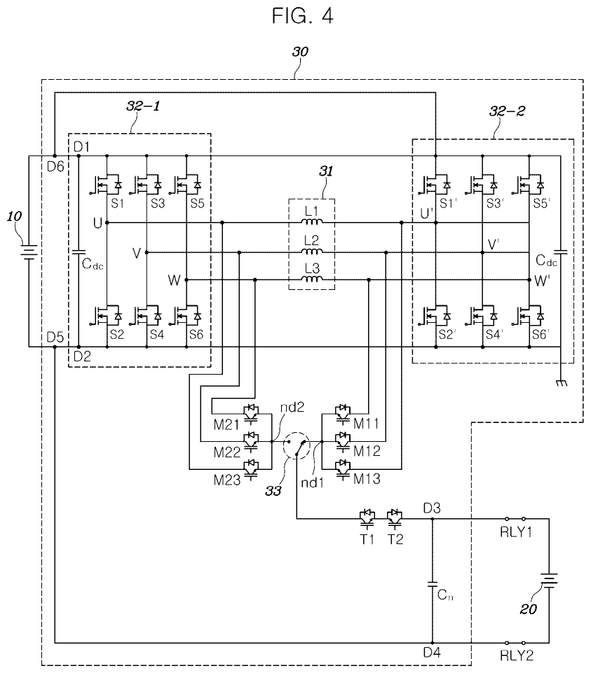

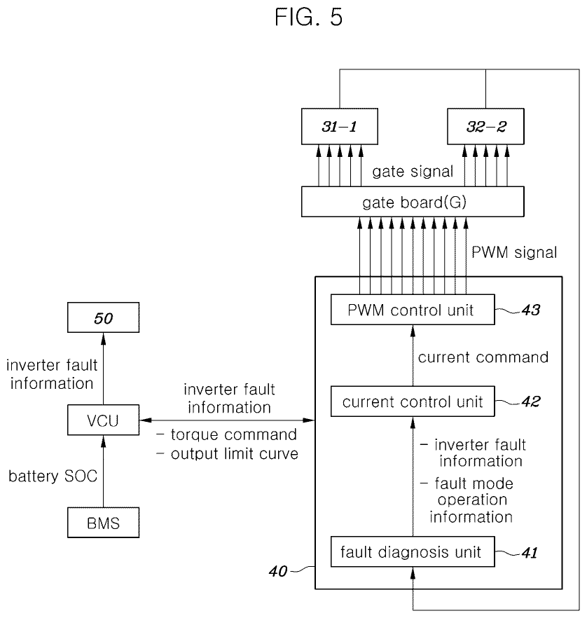

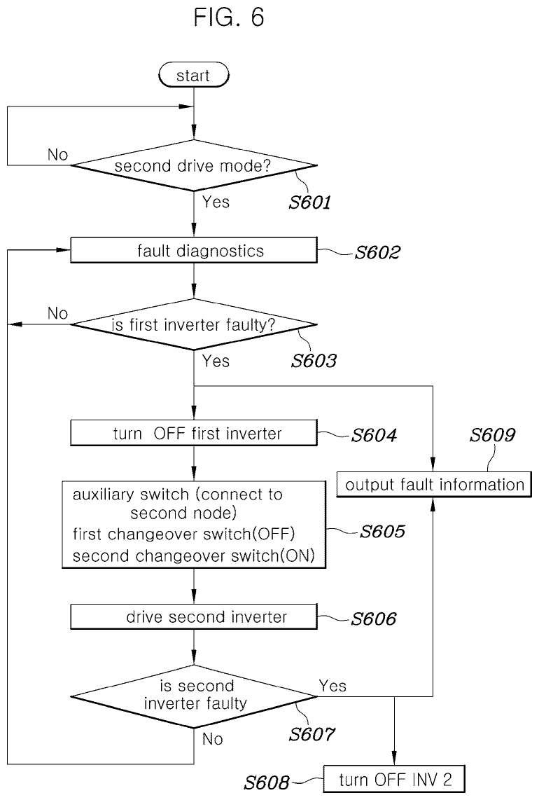

The configuration of an electrified vehicle according to an exemplary embodiment of the present disclosure will be first described with reference to FIG. 1, FIG. 2, FIG. 3, FIG. 4, FIG. 5 and FIG. 6 below.

FIG. 1 is a view exemplarily illustrating the configuration of an electrified vehicle according to an exemplary embodiment of the present disclosure.

FIG. 1 shows that the electrified vehicle according to an exemplary embodiment of the present disclosure includes a main battery 10, a motor system 30, a controller 40, and an output device 50 and may be provided with an auxiliary battery 20. In the following, the description will assume that the electrified vehicle according to an exemplary embodiment of the present disclosure is provided with the auxiliary battery 20.

The motor system 30 may include a motor provided as a power source for the electrified vehicle and at least one inverter driving the motor and may be connected between the main battery 10 and the auxiliary battery 20.

The motor system 30 may drive the motor through operation of the inverter based on the voltage of the main battery 10.

Furthermore, in an electrified vehicle according to an exemplary embodiment of the present disclosure, the auxiliary battery 20 may be selectively connectable to the motor system 30, and the auxiliary battery 20 may supply power to the motor system 30 when the auxiliary battery 20 is connected to the motor system 30. In the exemplary embodiments of the present disclosure, the auxiliary battery 20 is distinct from the main battery 10. For example, the capacity or voltage of the auxiliary battery 20 may be lower than the capacity or voltage of the main battery 10. Furthermore, the auxiliary battery 20 is also distinct from the low-voltage (e.g., 12 V) battery used to operate electrical components in that the auxiliary battery may be utilized to drive the motor 31, and the auxiliary battery 20 may have a larger capacity or higher voltage than the low-voltage battery used to operate electrical components.

In the instant case, the auxiliary battery 20 may be utilized as a power source for the motor drive or may be utilized to supply power to the main battery 10 through the motor system 30 to charge the main battery 10. Furthermore, the auxiliary battery 20 may also be charged by receiving power from the main battery 10 through the motor system 30.

On the other hand, the controller 40 may be configured for controlling the operating and switching status of the inverter included in the motor system 30. The controller 40 may be configured for controlling the motor system 30 in either a first drive mode in which the auxiliary battery 20 and the motor are electrically disconnected or a second drive mode in which the auxiliary battery 20 and the motor are electrically connected, check whether the motor system 30 is faulty, and control the motor system 30 based on the check results.

In an implementation, the controller 40 may be implemented as a single controller or may be implemented as a plurality of controllers across which its functions are distributed. For example, the controller 40 may be implemented as a combination of a motor control unit (MCU) that is configured to control the motor of the motor system 30 and a higher-level control unit (e.g., hybrid control unit (HCU), vehicle control unit (VCU), hydrogen fuel cell control unit (FCCU)), and the like but are not necessarily limited thereto. According to another implementation, the controller 40 may further include a charging controller.

The output device 50 may be connected to the controller 40 to output information obtained from the controller 40. In the instant case, the outputting may be performed by transmitting the information obtained from the controller 40 to a vehicle user in a visual or auditory form. For example, such an output device 50 may be implemented as a device including a screen or a voice output device such as audio video navigation telematics (AVNT), a cluster, and the like provided inside a vehicle or may also be implemented as a user terminal such as a smartphone communication-connected to the controller 40 in various exemplary embodiments of the present disclosure.

As described above, the motor system 30 may be electrically connected to the auxiliary battery 20 as well as the main battery 10 during the second drive mode, and in the instant case, the power of the auxiliary battery 20 may be utilized to increase the driving distance. A structure for the present end is illustrated in FIG. 2, FIG. 3 and FIG. 4.

FIG. 2, FIG. 3 and FIG. 4 are views for describing an implementation example of a motor system applicable to the exemplary embodiments of the present disclosure.

First, FIG. 2 shows that the motor system 30 according to various exemplary embodiments of the present disclosure may include a motor 31, a first inverter 32-1, a second inverter 32-2, a plurality of first changeover switches M11, M12, M13, a plurality of second changeover switches M21, M22, M23, an auxiliary switch 33, charging switches T1, T2, and direct current capacitors Cdc, Cn. Furthermore, the motor system 30 may have direct current connection points D1, D2, D3, D4, D5, D6 connected to the main battery 10 and the auxiliary battery 20.

The motor 31 may include a plurality of windings L1, L2, L3 corresponding to each of phases U, V, W. The first inverter 32-1 may have direct current connection points D1, D2 connected to the main battery 10. It may include a plurality of legs S1-S2, S3-S4, S5-S6 connected to one end of each of the windings L1, L2, L3 included in the motor 31. The second inverter 32-2 may include a plurality of legs S1′-S2′, S3′-S4′, S5′-S6′ connected to the other end of each of the windings L1, L2, L3.

The plurality of first changeover switches M11, M12, M13 may have one end interconnected to form a first node nd1 and the other end respectively connected to the other end of each of the windings L1, L2, L3. The plurality of second changeover switches M21, M22, M23 may have one end respectively connected to one end of each of the windings L1, L2, L3 and the other end interconnected to form a second node nd2.

The plurality of first changeover switches M11, M12, M13 and the plurality of second changeover switches M21, M22, M23 may be turned on/off according to specific drive modes through the first inverter 32-1 and the second inverter 32-2 in the first drive mode.

The first drive mode may include a closed end winding (CEW) mode and an open end winding (OEW) mode. First, the plurality of first changeover switches M11, M12, M13 or the plurality of second changeover switches M21, M22, M23 may be turned on in the CEW mode. When the plurality of first changeover switches is turned on and the plurality of second changeover switches is turned off, the first node nd1 becomes the neutral point of the motor 31 and the motor 31 is driven only through the first inverter 32-1 accordingly. In contrast, when the plurality of second changeover switches is turned on and the plurality of first changeover switches is turned off, the second node nd2 becomes the neutral point of the motor 31 and the motor 31 is driven only through the second inverter 32-2 accordingly. In the present manner, the CEW mode in which the motor 31 is driven only through one of the first inverter 32-1 and the second inverter 32-2 may be performed for an effective drive of the motor 31 in a low output interval.

In contrast, both the plurality of first changeover switches and the plurality of second changeover switches may be turned off in the OEW mode of the first drive mode. In the instant case, neither the first node nd1 nor the second node nd2 becomes the neutral point of the motor 31, and both the first inverter 32-1 and the second inverter 32-2 may drive the motor 31 accordingly. The OEW mode in which the first inverter 32-1 and the second inverter 32-2 drive the motor 31 together in the present manner may be performed to enhance the drive power of the motor 31 in a high output interval.

On the other hand, the auxiliary switch 33 may have one end selectively connectable to the first node nd1 or the second node nd2 and the other end selectively connectable to the auxiliary battery 20, and the charging switches T1, T2 may be connected between the auxiliary switch 33 and the auxiliary battery 20. The charging switches T1, T2 may be connected to one of the first node nd1 and the second node nd2 through the auxiliary switch 33. In the exemplary embodiment of the present disclosure, the charging switches T1, T2 may be implemented as an insulated gate bipolar transistor (IGBT) but may be implemented as other elements configured to perform switching operations, such as a metal oxide semiconductor field effect transistor (MOSFET) and the like, depending on embodiments.

The first drive mode or the second drive mode described above may be executed according to the turn-on/off status of the charging switches T1, T2. The charging switches T1, T2 are turned off during the first drive mode. In the instant case, the auxiliary battery 20 is electrically disconnected from the motor 31.

In contrast, the charging switches T1, T2 are turned on during the second drive mode. In the instant case, the auxiliary battery 20 is electrically connected to the motor 31 through the first node nd1 or the second node nd2 connected to the auxiliary switch 33.

On the other hand, the motor system 30 may be connected to the auxiliary battery 20 through relays RLY1, RLY2. In the instant case, the relay RLY1 may be connected between the positive terminal of the auxiliary battery 20 and a direct current connection point D3, and the relay RLY2 may be connected between the negative terminal of the auxiliary battery 20 and a direct current connection point D4.

In embodiments, the phrase “with the auxiliary battery 20 mounted” may indicate that relays RLY1, RLY2 are turned on and that the auxiliary battery 20 is connected to the motor system 30. However, even when the relays RLY1, RLY2 are turned on and the auxiliary battery 20 is mounted, the auxiliary battery 20 may be electrically connected to or disconnected from the motor 31 depending on the turn-on/off status of the charging switches T1, T2.

The positive terminal of the auxiliary battery 20 may be connected to the auxiliary switch 33 through the charging switches T1, T2 and relays RLY1, RLY2 and connected to the first node nd1 or the second node nd2 according to the connection status of the auxiliary switch 33. The negative terminal of the auxiliary battery 20 may be connected to the direct current connection point D4.

On the other hand, as illustrated in FIG. 1, no separate relay may be provided between the main battery 10 and the motor system 30, but a relay may be provided between the main battery 10 and the motor system 30 in various exemplary embodiments of the present disclosure.

The direct current capacitors Cdc, Cn may be provided to mitigate current ripple. A direct current capacitor Cdc connected between the direct current connection point D1 and the direct current connection point D2 may mitigate ripple in the current from the main battery 10, and the direct current capacitor Cn connected between the direct current connection point D3 and the direct current connection point D4 may mitigate ripple in the current from the auxiliary battery 20.

On the other hand, while the motor 31 is driven in the second drive mode, fault diagnostics of at least one of the first inverter 32-1 and the second inverter 32-2 may be performed, and the connection status of the auxiliary switch 33 may be controlled based on diagnosis results.

First, when the diagnostics results indicate that the first inverter 32-1 is faulty, the controller 40 may be configured for controlling to connect one end of the auxiliary switch 33 to the second node, as illustrated in FIG. 3. Furthermore, in the instant case, the controller 40 may turn on the plurality of second changeover switches M21, M22, M23 and drive the motor through the second inverter 32-1.

In other words, when the first inverter 32-1 is faulty, the second drive mode may be performed through the switching operation of the second inverter 32-2 based on the voltage of the auxiliary battery 20.

In contrast, when the diagnostics results indicate that the second inverter 32-2 is faulty, the controller 40 may be configured for controlling to connect one end of the auxiliary switch 33 to the first node nd1, as illustrated in FIG. 4. Furthermore, in the instant case, the controller 40 may turn on the plurality of first changeover switches M11, M12, M13 and drive the motor 31 through the first inverter 32-1.

Detailed configuration and operation of the controller 40 will be described with reference to FIG. 5 below.

FIG. 5 is a view for describing the detailed configuration and operation of the controller according to an exemplary embodiment of the present disclosure.

FIG. 5 shows that the controller 40 may include a fault diagnosis unit 41, a current control unit 42, and a PWM control unit 43. In the instant case, the controller 40 may be a motor controller, for example.

First, the fault diagnosis unit 41 may perform fault diagnostics on the first inverter (32-1) and the second inverter (32-2) based on factors such as overheating, overcurrent or overvoltage, open/short circuits, power supply status for switching operations, and signal input status of the first inverter 32-1 and the second inverter 32-2.

Based on the fault diagnosis results, the fault diagnosis unit 41 may transmit inverter fault information along with operation information corresponding to the fault status of the first inverter 32-1 and the second inverter 32-2 to the current control unit 42.

The current control unit 42 may be configured to generate a current command based on the inverter fault information and corresponding operation information received from the fault diagnosis unit 41, a torque command received from the vehicle control unit (VCU), and an output limit curve. For example, the current control unit 42 may be configured to generate a current command that enables the second inverter 32-2 to perform switching operations that satisfy the torque command under the output limit curve when the first inverter 32-1 is faulty and generate a current command that enables the first inverter 32-1 to perform switching operations that satisfy the torque command under the output limit curve when the second inverter 32-2 is faulty.

Furthermore, the inverter fault information and corresponding operation information may be transmitted to an output device 50 through the vehicle control unit, and the output device 50 may output the inverter fault information. The VCU may be connected to the battery management system (BMS), obtain the state of charge (SOC) value of the first battery 10 or the second battery 20 from the BMS, and transmit it to the controller 40.

On the other hand, the generated current command may be transmitted to the pulse width modulation (PWM) control unit 43, and the PWM control unit 43 may output a modulated PWM signal based on the current command to a gate board (G). The gate board (G) transmits a gate signal to at least one of the first inverter 32-1 and the second inverter 32-2 according to the input PWM signal, and the inverter receiving the gate signal drives the motor 31 through a switching operation according to the gate signal.

Herein, in an exemplary embodiment of the present disclosure, the fault diagnosis unit 41, the current control unit 42, and the PWM control unit 43 may be implemented as separate processors. Alternatively, the fault diagnosis unit 41, the current control unit 42, and the PWM control unit 43 may be implemented as a single integrated processor.

The control process of an electrified vehicle described thus far will be described with reference to a flowchart below.

FIG. 6 is a flowchart for describing a control method of an electrified vehicle according to an exemplary embodiment of the present disclosure.

FIG. 6 illustrates a fault diagnosis and corresponding control process, assuming that the motor 31 is being driven through the first inverter 32-1.

First, when the motor 31 is driven in the second drive mode (YES in S601), the controller 40 is configured to perform fault diagnostics on the inverter (S602). The controller 40 may first perform fault diagnostics on the first inverter 32-1, assuming that the motor 31 is driven through the first inverter 32-1.

When the diagnosis results indicate that the first inverter 32-1 is faulty (YES in S603), the controller 40 may terminate the driving of the motor 31 through the first inverter 32-1. In the instant case, all switching elements included in the first inverter 32-1 may be turned off (S604).

Accordingly, the controller 40 may connect one end of the auxiliary switch 33 to the second node nd2, turn off the plurality of first changeover switches M11, M12, M13, turn on the plurality of second changeover switches M21, M22, M23, and connect the auxiliary battery 10 to the second inverter 32-2 (S605).

As a result, the second inverter 32-2 may drive the motor 31 based on the voltage of the main battery 10 and the auxiliary battery 20 (S606). However, when the second inverter 32-2 is also faulty (YES in S607), the operation of the second inverter 32-2 is also terminated, and the driving of the motor 31 is terminated consequently.

On the other hand, when the first inverter 32-1 or the second inverter 32-2 is diagnosed with a fault, (YES in S603 or YES in S607), the controller 40 transmits the present information to the output device 50 so that the fault information is output (S609).

According to various embodiments of the present disclosure as described above, an auxiliary battery may be utilized in conjunction with a main battery for motor drive so that the driving distance of the electrified vehicle increases efficiently.

Furthermore, the inverters driving the motor may be changed based on the voltage of the main battery and auxiliary battery to reflect the fault status of the inverter so that vehicles may continue driving even in the event of an inverter fault, such as burnout or damage of elements in the inverter.

Furthermore, the term related to a control device such as “controller”, “control apparatus”, “control unit”, “control device”, “control module”, “control circuit”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electrified vehicle configured to accommodate an auxiliary battery, the electrified vehicle comprising:
a main battery;
a motor including a plurality of windings;
a first inverter including a plurality of legs connected to the main battery and connected to a first end of each of the windings;
a second inverter including a plurality of legs connected to the main battery and connected to a second end of each of the windings;
a plurality of first changeover switches, each including a first end interconnected to form a first node and a second end connected to the second end of each of the windings;
a plurality of second changeover switches, each including a first end connected to the first end of each of the windings and a second end interconnected to form a second node; and
an auxiliary switch including a first end selectively connectable to the first node or the second node and a second end selectively connectable to the auxiliary battery in a state where the auxiliary battery is mounted.

2. The electrified vehicle of claim 1, further including a charging switch connected between the second end of the auxiliary switch and the auxiliary battery.

3. The electrified vehicle of claim 2, further including a controller configured to control drive modes of the motor by turning on/off the charging switch.

4. The electrified vehicle of claim 3, wherein the drive mode includes:
a first drive mode in which the motor is driven in a state where the auxiliary battery and the motor are electrically disconnected by the charging switch being turned off; and
a second drive mode in which the motor is driven in a state where the auxiliary battery and the motor are electrically connected by the charging switch being turned on.

5. The electrified vehicle of claim 4, wherein the controller is further configured to perform fault diagnostics on at least one of the first inverter and the second inverter while controlling the motor in the second drive mode and to control a connection status of the auxiliary switch based on diagnosis results.

6. The electrified vehicle of claim 5, wherein the controller is further configured to connect the first end of the auxiliary switch to the second node in response to the first inverter being diagnosed with a fault.

7. The electrified vehicle of claim 6, wherein the controller is further configured to turn on the plurality of second changeover switches and to drive the motor through the second inverter in response to the first inverter being diagnosed with the fault.

8. The electrified vehicle of claim 5, wherein the controller is further configured to connect the first end of the auxiliary switch to the first node in response to the second inverter being diagnosed with a fault.

9. The electrified vehicle of claim 8, wherein the controller is further configured to turn on the plurality of first changeover switches and to drive the motor through the first inverter in response to the second inverter being diagnosed with the fault.

10. The electrified vehicle of claim 5, further including an output device which is operatively connected to the controller and outputs the diagnosis results.

11. A method for controlling the electrified vehicle of claim 1, the method including:
controlling, by a controller, a drive mode of the motor through a turn-on/off of charging switches connected between the auxiliary battery and the second end of the auxiliary switch either in a first drive mode in which the motor is driven in a state where the auxiliary battery and the motor are electrically disconnected or in a second drive mode in a state where the motor is driven in a state where the auxiliary battery and the motor are electrically connected; and
performing fault diagnostics on at least one of the first inverter and the second inverter while controlling the motor in the second drive mode and controlling a connection status of the auxiliary switch based on diagnosis results, in a state where the auxiliary battery is mounted.

12. The method of claim 11, wherein the controlling of the connection status of the auxiliary switch includes connecting the first end of the auxiliary switch to the second node in response to the first inverter being diagnosed with a fault.

13. The method of claim 12, further including turning on, by the controller, the plurality of second changeover switches and driving the motor through the second inverter in response to the first inverter being diagnosed with the fault.

14. The method of claim 11, wherein the controlling of the connection status of the auxiliary switch includes connecting the first end of the auxiliary switch to the first node in response to the second inverter being diagnosed with a fault.

15. The method of claim 14, further including turning on, by the controller, the plurality of first changeover switches and driving the motor through the first inverter in response to the second inverter being diagnosed with the fault.

16. The method of claim 11, further including outputting, by the controller, the diagnosis results through an output device operatively connected to the controller.
